(19) United States
(12) Patent Application Publication
(10) Pub. No.: US 2012/0007377 A1
(43) Pub. Date: Jan. 12, 2012

(54) Trim Component For The Interior Of A Motor Vehicle

(75) Inventors: Jürgen BUCHHEIT, Hamburg (DE); Manfred HOFFMANN, Nienhof (DE); Rüdiger REZEK, Nienhagen (DE); Carsten KLIWER, Braunschweig (DE); Karl-Heinz WEBER, Celle (DE)

(73) Assignee: INTERNATIONAL AUTOMOTIVE COMPONENTS GROUP GMBH, Krefeld (DE)

(21) Appl. No.: 13/157,834

(22) Filed: Jun. 10, 2011

(30) Foreign Application Priority Data
Jun. 10, 2010 (DE) 10 2010 017 321.5

(51) Int. Cl. B60R 13/02

(52) U.S. Cl. 296/1.08

(57) ABSTRACT

Trim component for the interior of a motor vehicle, in particular floor lining component for a loading platform of a motor vehicle, with a cassette profile layer in which a plurality of cavities are formed, which are open towards a supporting or abutting side of the trim component and on the opposite use surface of the trim component, are sealed by an airtight use layer which rests on the use surface of the trim component, or by an airtight surface of the cassette profile layer, wherein the cavities of the cassette profile layer are filled with air and wherein the columns of air enclosed in the cassette profile layer, form in connection with the use layer an acoustic spring-mass system.

### FIELD OF THE INVENTION

The invention relates to a trim component for the interior of a motor vehicle, in particular a floor covering for the loading platform of a motor vehicle.

### BACKGROUND OF THE INVENTION

In small utility vehicles, such as pickup trucks and transporters, the loading platform frequently has a tread-proof covering which lies directly on the body sheet. This floor covering is generally a flat, only slightly shaped component, which is required to be pressure-resistant and tread-proof and to provide a high degree of noise insulation with a low surface weight. In the prior art for example foam-backed carpets based on PU foam are used for this. In the selection and setting of the material, a compromise must be found between sufficient hardness to produce the desired loading capacity and a secure tread sensation and a sufficient acoustic damping, which requires a softer material. The hard bodies necessary to support higher loads are generally not, or not sufficiently, effective acoustically and do not produce the desired noise insulation.

From DE 41 31 394 C2 a sound-damping material is known, with a core layer which has a honeycomb structure of porous board and with at least one covering layer of a fiber mat which is permeable to air. The cavities of the honeycomb structure are filled with a sound-damping recycled material of polyurethane foam, textile fibres or foam glass. The sound-damping material serves for example as a side wall covering, boot or parcel shelf covering, floor covering of the passenger compartment, door trim etc., i.e. in areas in which it is not exposed to any appreciable pressure load.

DE 102 55 039 A1 describes a composite trim part for inner trim parts or coverings of vehicles with a core layer forming a cavity, which is arranged between two layers of a natural fibre/thermoplast composite material. The core layer is closed in an air-tight manner by the two cover layers. Similar sandwich components with a core material of paper honeycomb, which is covered on both sides by a glass fabric and is coated with a PUR hard foam, are available on the market. These sandwich components are pressed in forming tools and allowed to react, in order to obtain light, rigid sheets with a closed surface, which are used in vehicles as readily resilient carrier materials. They have no appreciable sound-damping characteristics. The use of such a construction for the loading platform of a motor vehicle is described for example in DE 103 10 368 A1.

In DE 103 17 670 A1 a hollow chamber element for motor vehicles is described, which uses a honeycomb sheet as reinforcement, which is encased by a plastic foam. The honeycomb sheet is provided on both sides with a foam layer, the fibres of which penetrate into the hollow chambers in order to achieve a certain sound-damping.

DE 197 02 581 A1 describes an inner trim element for the body of a vehicle with a carrier layer of corrugated board, the honeycomb-shaped cavities of which are foam-filled, in order to obtain the desired form stability and sound-damping.

JP-2009 073401 describes a loading platform for a motor vehicle with a core layer of impregnated paper honeycomb, which is coated on both sides.

US 2006/0080941 A1 describes a floor covering for the passenger compartment of a motor vehicle, which has a core layer with a honeycomb structure, which are coated on both sides. By forming small holes in the cover layers, a certain sound absorption is achieved.

WO 01/92086 A1 describes a floor covering for a motor vehicle with a bearing honeycomb core layer of impregnated board, which is provided on both sides with reinforcement layers, in order to form a supporting structure with high stability. On one side of the supporting structure, is applied a PU foam layer as spring and a rubber or latex layer as mass, in order to provide an acoustically absorbing spring-mass system for the floor group.

WO 99/61284 A1 discloses an acoustically effective insulation covering for vehicles which is configured with three different functional zones. A first zone comprises a cover layer which imparts stability and tread-resistance to the component and which serves as a mass-layer. The second zone consists of a plurality of open cells, the cell walls and enclosed air taking on the function of an elastic spring. A third zone provides a distance between the second zone and the car body using small spacers. The purpose of the third zone is to generate a lateral air stream between the individual cells.

EP 1 045 775 B1 discloses a sound and shock absorbing vehicle lining including at least one support layer, an intermediate layer and a cover layer wherein the intermediate layer comprises a plurality of adjacent cavities, the walls of which are provided with break-throughs to form a continuous cavity labyrinth. There is a continuous air layer between the vehicle lining and the car body to be lined.

DE 196 27 106 A1 describes a sound insulating insert of similar construction, comprising an upper surface and a bottom surface as well as a support body including a plurality of recesses which extend between the upper surface and the bottom surface. The recesses are connected to each other via traverse connection channels and are filled completely or partly by a porous material, such as non-woven or foam material.

The overview of the prior art shows that it is known to use a honeycomb structure element, e.g. an impregnated paper or board honeycomb as a core layer in inner trim parts and floor coverings of motor vehicles, which is provided with cover layers on both sides to achieve the structural strength. For sound-damping, it is additionally known to fill the cavities of the honeycomb structure with a foam or to apply additional foam layers onto the supporting structure. It is also known to later provide a cover layer with small holes, in order to achieve a certain sound absorption.

Starting from this prior art, it is an object of the invention to provide a lining or trim component for the interior of a motor vehicle, in particular a floor covering for a loading platform of a motor vehicle, which is simple in construction and has a low weight, and which has optimum acoustic characteristics and an excellent pressure resistance.

### SUMMARY OF THE INVENTION

The invention provides a lining or trim component for the interior of a motor vehicle, in particular a floor covering for a loading platform of a motor vehicle, including a cassette profile layer, in which a plurality of cavities are formed, which are open towards a supporting or abutting side of the trim component, and a use layer, which rests on the use surface of the trim component on the cassette profile layer or is connected thereto. The cavities of the cassette profile layer are filled with air, and the trim component as a whole is designed so that the columns of air enclosed in the cassette profile layer in combination with an air-tight use layer or a surface of the cassette profile layer sealing the use surface in an air-tight manner form an acoustic spring-mass system. The invention solves the conflict between the opposing requirements for high loading capacity and for being tread-proof, and for good sound-damping, in that it provides an acoustic spring-mass system in which, as the spring, the air cushion is used which is present in the downwardly open cavities of the cassette profile layer, whilst the tread-proof characteristic is achieved by the cassette profile itself. The mass is formed by the use layer, via which also the tread comfort can be set. The cassette profile layer, coupled to the use layer, also contributes to the acoustically effective mass, when it is mechanically connected therewith.

In the preferred embodiment of the invention, the cavities of the cassette profile layer are separated in the manner of a honeycomb structure by walls which run substantially perpendicularly to the supporting or abutting surface of the trim component and largely prevent a propagation of sound parallel to the supporting or abutting surface. The cassette profile according to the invention is, however, not restricted to a honeycomb structure, but may have cavities of almost any desired shape, which are open towards the supporting or abutting side of the trim component receiving the sound. Whilst the size of the cavities is less critical for the acoustic function of the trim component, it is important for the load-bearing capacity. With an overall height of the trim component for example of 10 to 30 mm, the diameter of the cavities should be approximately 5 to 20 mm, for example approximately 1 cm. These values should be understood as exemplary without limiting the invention thereto. The cavities are open over their entire diameter on the supporting or abutting side, i.e. are not, for example, only punctuated. Smaller honeycomb sizes increase the structural stability of the cassette profile layer. Naturally, with smaller cavity sizes the weight of the entire structure also increases; a suitable compromise can be found by the person skilled in the art, without great expenditure.

The individual cavities of the cassette profile layer are open towards the bottom and are separated in a lateral direction by sidewalls, that is by walls separating the cavities or honeycombs. The side walls are not pervious to air. Different from the prior art, partly discussed above, there are no lateral connection channels and there is no exchange of air through the side walls of the cavities between the individual cavities. The cassette profile layer rests on the vehicle body either directly or via a cover layer, which is specified further below, so that also at the bottom side of the cassette profile layer there is no or substantially no lateral exchange of air or air transmission. More specifically, different from part of the prior art discussed above, there is for example no spacer between the cassette profile layer and the car body which would allow or support a lateral air flow at the bottom side of the cassette profile layer. Rather, the cassette profile layer, with the bottom edges of the side walls separating the cavities, rests directly, or via the additional cover layer, on the body of the vehicle.

In the preferred embodiment of the invention, the cavities of the cassette profile layer contain only air; i.e. they are not filled with foam, granulate, fibres or another sound-damping material. It has been found that very good sound-damping characteristics can be obtained when the column of air which is enclosed in the cassette profile layer is used as a very soft spring and thus in connection with the use layer in the acoustic sense a light, effective mass-spring system is formed. The profile itself additionally produces the desired tread-proof characteristic.

In the preferred embodiment, the use layer is air-tight; more specifically, it has a flow resistance of at least 3000 Ns/m³. The use layer can serve to seal the cavities of the cassette profile layer in an air-tight manner on the use surface of the trim component. This means that the cassette profile layer can be initially constructed so that it has open cavities on both sides, with the cavities then being sealed in a largely air-tight manner on the use surface of the trim component by the use layer. For this, the use layer can be connected with the cassette profile layer directly or fixedly or detachably via an elastic intermediate layer. Alternatively, the cassette profile layer can, however, also be produced with cavities which are closed on one side.

The cassette profile layer can be produced from a shear-resistant material, such as a thermoplastic or duroplastic foil or from a finished paper, in particular an impregnated paper. The finishing of the paper serves both to increase the stability of the paper and also as protection against penetrating water and moisture and contamination. With the use of resins and hard waxes, the resilience of a paper profile against moisture and deformation increases to a particular extent. A commercially available impregnated paper honeycomb can also be used. For impregnating the paper, e.g. resin, latex, oil, wax or bitumen can be used. Alternatively or additionally, the paper can be coated, sprinkled or sprayed.

The use layer can be constructed having one, two or several layers. Thus, the use layer can be produced simply from an elastomer material. In another embodiment, the use layer consists of a textile material which is coated on one side so as to be imperviously sealed, or for example of a non-woven material onto which an air-tight, in particular thermoplastic foil is applied. More generally, the use layer, if it is two-layered, can be constructed from one layer with an open or closed textile structure or with a closed thermoplastic structure, e.g. of TPO or TPE, and from a second layer of a mixed or pure non-woven material, which is optionally thermoplastic- or resin-bonded. In connection, the two layers are preferably airtight and also prevent passing through or punching through. The second layer further serves to set the tread sensation.

The trim component according to the invention is generally substantially flat; it serves in particular as floor covering for a loading surface of utility vehicles or in similar situations, in which the abutting or supporting surface has a slight three-dimensional shaping and is largely flat, for example in the floor of a luggage compartment. The trim component provides a smooth and resilient loading platform and is able to balance out unevenness, such as corrugations of a floor pan. This balancing takes place on the one hand by the cover layer and on the other hand by a slight shaping of the cassette profile layer on the supporting or abutting side.

The trim component according to the invention achieves an excellent sound-damping also without the use of an additional decoupling layer e.g. of foam. In a first embodiment of the invention, it is constructed only from the cassette profile layer and the use layer. In another embodiment, it is constructed only from the cassette profile layer, the use layer and the cover layer. Further materials, in particular additional foam layers, are not necessary.

The trim component according to the invention can be prefabricated and in the assembled state can be used as a loading platform, inner trim part or the like in a motor vehicle. However, it is also possible to provide the layers individually and to mount them in individual parts in the vehicle. This offers on the one hand a higher degree of flexibility as regards the composition of the trim component; however, it also increases the possibility of recycling, because the trim component can be dismantled again into its various components without difficulty.

In summary, the invention solves the conflicting interests between high sound-damping and a good tread-proof characteristic, by an acoustic spring-mass system being provided, in which the cushion of air which is present in the cavities of the cassette profile layer is used as soft spring, whilst the tread-proof characteristic is achieved by the honeycomb structure of the cassette profile layer. Through the soft spring, only a relatively small mass is necessary, in order to achieve a good sound insulation, wherein the cassette profile layer can also contribute to the mass. The tread comfort can be set by thin layers of non-woven material or other soft layers between the cassette profile layer and the use layer. A further thin layer of non-woven material or similar soft layer on the underside of the cassette profile layer serves the same purpose and prevents connecting noises of the trim component on the body, for example on the floor pan.

### SHORT DESCRIPTION OF DRAWINGS

The invention is explained further below with reference to preferred embodiments. In the drawings:

FIG. 1 shows a schematic sectional view through a trim component according to the invention;

FIG. 2 shows a schematic sectional view through a trim component according to an alternative embodiment of the invention;

FIGS. 3, 4 and 5 show schematic sectional views through alternative embodiments of the use layer.

### DETAILED DESCRIPTION OF EMBODIMENTS

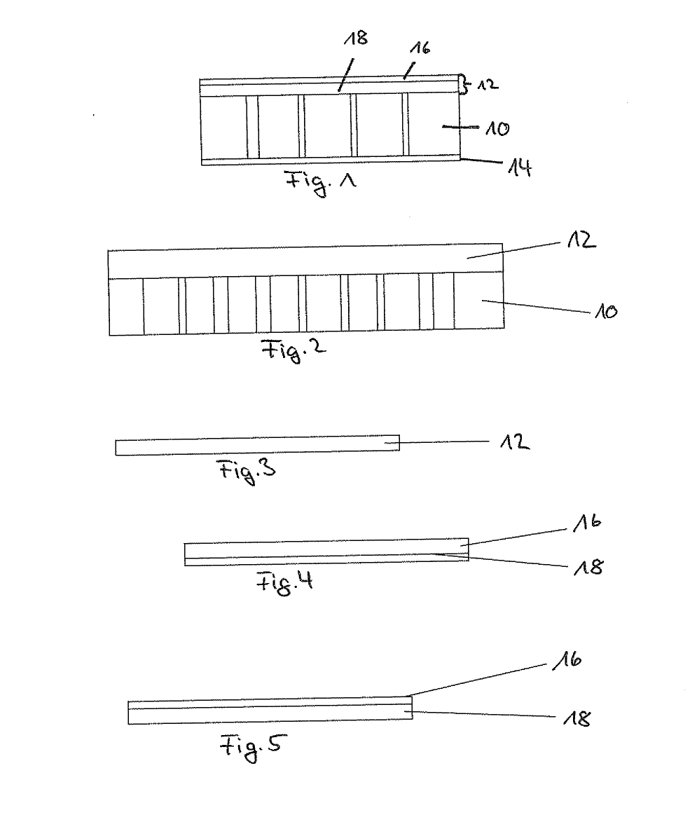

FIG. 1 shows a schematic sectional view through a trim component according to the invention. In the embodiment which is shown, the trim component serves as a tread-proof, light, acoustically effective floor covering for flat and slightly shaped floor groups of a motor vehicle. The trim component according to the invention can, however, also be used in the area of racks and luggage compartment floors and boot floor coverings and other inner trim parts.

In the embodiment which is shown, the trim component comprises a cassette profile layer 10, a two-layered use layer 12 and a cover layer 14. The cassette profile layer 10 is formed for example by an impregnated paper honeycomb, preferably by a finished paper profile, which is impregnated against contamination and the penetration of moisture by resin, latex, an emulsion, an oil, wax or bitumen. Thermoplastic or duroplastic profiles can also be used.

The walls separating the sidewalls of the individual cavities or honeycombs of the cassette profile layer 10 are impervious to air and do not include any passages, connection channels or the like.

The use layer 12 can be embodied in two layers, as shown in FIG. 1, with a cover layer 16 having an open or closed textile structure or with a closed thermoplastic structure, e.g. of TPO or TPE, and an intermediate layer 18 of a mixed fibre or pure fibre non-woven material, which can be thermoplastic- or resin-bonded.

On the opposite supporting or abutting side of the trim component, the cover layer 14 is arranged, in particular a cover non-woven material, which is permeable to air and which does not seal in an airtight manner the cavities of the cassette profile layer which are open towards the supporting or abutting side of the trim component.

In FIG. 2 an alternative embodiment of the trim component is illustrated with only a cassette profile layer 10 and a use layer 12. In this embodiment, the use layer 12 is single-layered and consists e.g. of an elastomer material. The cover layer 14 is not necessary for the acoustic effect and can therefore be omitted.

Irrespective of whether the cover layer 14 is provided or not, the trim component according to the invention is configured so that its bottom edges of the walls separating the cavities of the cassette profile layer rest directly, or via the cover layer 14, on the body of the vehicle. There is no lateral air flow in this area but the spring of the spring-mass system is substantially formed by only the air enclosed in the cavities.

FIGS. 3 to 5 show various embodiments of the use layer, wherein FIG. 3 shows a single-layered use layer 12 of an elastomer material; FIG. 4 shows a two-layered use layer with a textile cover layer 16 and a sealing foil lying therebeneath as intermediate layer 18; whilst FIG. 5 shows a two-layered use layer with a thermoplastic cover foil 16 and a non-woven material lying therebeneath as intermediate layer 18. The textile material and the non-woven material can produce a pleasant tread sensation and have the additional benefit that falling objects or heels of shoes can not penetrate the structure. In the preferred embodiment, the use layer is airtight and seals the trim component towards the top in an airtight manner. When the cassette profile layer itself has a surface sealing the use side in an airtight manner, the use layer can then also be permeable to air.

A trim component with a thermoplastic or thermoplastic-finished cassette profile layer can be brought into the desired shape by a thermoforming process, wherein the cassette profile layer is only to be shaped within limits. The trim component can be produced for example in that e.g. a paper honeycomb structure is impregnated, sprinkled, sprayed or impregnated in a similar manner with resin, at least the use layer is applied onto the honeycomb structure and the composite is heated and shaped. On cooling, the trim component solidifies in the desired shape. Cassette profile layers which use polymerized resins can be shaped e.g. by a pressing method and adapted to the associated supporting or abutting surface.

The cover layer 14 protects the cassette profile layer against the penetration of foreign bodies and moisture. In addition, it separates the trim component from the supporting or abutting surface and prevents connection noises to the supporting or abutting surface, such as friction and/or rattling noises.

According to the invention, the cassette profile layer does not serve merely as a carrier structure, to receive foam or granulate, or as a tread reinforcement in a foam-backed floor covering or only as a spacer, but rather in addition to its carrier function in connection with the use layer it forms an acoustic element. The column of air enclosed in the cassette profile layer as a spring forms, in combination with the use layer, a light, effective mass-spring system in the acoustic sense. In addition, the profile produces the desired tread-proof characteristic.

The features disclosed in the above description, the claims and the figures can be of significance both individually and also in any desired combination for the realization of the invention in its various embodiments.

1. A trim component for the interior of a motor vehicle, in particular a trim component for the floor surface of a motor vehicle, including a cassette profile layer, in which a plurality of cavities are formed, which are open towards a supporting or abutting side of the trim component, and a supported use layer, wherein the cavities of the cassette profile layer are filled with air and wherein the columns of air enclosed in the cassette profile layer in combination with
(i) an airtight use layer or
(ii) a surface of the cassette profile layer sealing the use side in an airtight manner
form an acoustic spring-mass system.

2. The trim component according to claim 1, characterized in that the cavities of the cassette profile layer are separated in the manner of a honeycomb structure by walls which run substantially perpendicularly to the supporting or abutting surface of the trim component and largely prevent sound propagation parallel to the supporting or abutting surface.

3. The trim component according to claim 1, characterized in that the cavities of the cassette profile layer contain only air.

4. The trim component according to claim 1, characterized in that the use layer is airtight or has a flow resistance of at least 3000 Ns/m³.

5. The trim component according to claim 1, characterized in that the use layer is connected directly or via an elastic intermediate layer with the cassette profile layer.

6. The trim component according to claim 1, characterized in that the cavities of the cassette profile layer are sealed in an airtight manner on a use surface by the use layer.

7. The trim component according to claim 1, characterized in that the use layer is securely or detachably connected to the cassette profile layer.

8. The trim component according to claim 1, characterized in that the cassette profile layer is produced from a shear-resistant material, such as thermoplastic or duroplastic foils or from a finished paper, in particular an impregnated paper.

9. The trim component according to claim 8, characterized in that the cassette profile layer is produced from a finished paper which is impregnated and/or coated with a resin, latex, an oil, wax or bitumen.

10. The trim component according to claim 1, characterized in that the use layer is constructed having one or several layers.

11. The trim component according to claim 1, characterized in that the use layer is produced from an elastomer material, a textile material which is coated at least on one side so as to be imperviously sealed, or from a non-woven material provided with a thermoplastic foil.

12. The trim component according to claim 1, characterized by a cover layer of a material, permeable to air, in particular a non-woven material, which is applied onto the supporting or abutting side of the cassette profile layer.

13. The trim component according to claim 1, characterized in that it is substantially flat.

14. The trim component according to claim 1, characterized in that it is produced without the use of an additional decoupling layer, in particular without the use of foam.

15. The trim component according to claim 1, characterized in that it is constructed only from the cassette profile layer and the use layer.

16. The trim component according to claim 1, characterized in that it is constructed only from the cassette profile layer, the use layer and the cover layer.

17. The trim component according to claim 1, wherein the cavities of the cassette profile layer are separated by air-impermeable walls so that there is no lateral air flow between the cavities through said walls.

18. The trim component according to claim 1 wherein the cavities of the cassette profile layer are separated by walls and the trim component is configured so that the bottom edges of its separating walls directly, or via a cover layer, abut against the floor pan of a vehicle wherein there is no or substantially no lateral air stream between the individual cavities of the cassette profile layer.
